(19) United States
(12) Patent Application Publication
(10) Pub. No.: US 2025/0269465 A1
(43) Pub. Date: Aug. 28, 2025

(54) VERTICAL LASER ENGRAVING APPARATUS

(71) Applicant: LensDigital, LLC, Old Bridge, NJ (US)

(72) Inventors: Leonid Karchevsky, Morganville, NJ (US); Eugene Miroshnichenko, Monroe Township, NJ (US)

(73) Assignee: LensDigital, LLC, Old Bridge, NJ (US)

(21) Appl. No.: 19/060,680

(22) Filed: Feb. 22, 2025

Related U.S. Application Data
(60) Provisional application No. 63/556,674, filed on Feb. 22, 2024.

(51) Int. Cl. B23K 26/08; B23K 26/362

(52) U.S. Cl. CPC B23K 26/0869; B23K 26/0823; B23K 26/362

(57) ABSTRACT

A vertical laser engraving apparatus is provided comprising a laser head secured to a vertical gantry and a gripping device secured to a horizontal rail. An object to be engraved extends vertically from the gripping device and the laser head emits a laser horizontal to the vertical gantry to contact the object to be engraved. The laser head is moveable along the vertical gantry by a vertical motor and the gripping device is movable along the horizontal rail. The gripping device is rotated about an axis by a rotational motor.

### CROSS-REFERENCE TO RELATED APPLICATION

This application claims the benefit of U.S. Provisional Patent Application No. 63/556,674, filed on Feb. 22, 2024, which is incorporated by reference herein in its entirety.

### FIELD OF THE INVENTION

The present disclosure is directed to a vertical laser engraving apparatus. Specifically, the present disclosure is directed to a laser engraving apparatus comprising a laser head positioned on a vertical gantry.

### INTRODUCTION

Light Amplification by Stimulated Emission of Radiation, colloquially referred to as a “laser,” is an artificially created beam of light. The beam of light emitted from a laser is comprised of a plurality of individual light waves, wherein the individual waves travel through space in synchronicity. Meaning, the individual waves of light travel in phase. Lasers, first created in 1960, were originally used for the purpose of furthering scientific understanding of atomic physics and chemistry. However, over time lasers made their way into manufacturing processes across a multitude of industries and today they are utilized for everything from cat toys to surgical procedures.

One common use of lasers is for engraving various tangible articles to add designs and other customizations. While there are various manners of facilitating engraving, the use of engraving apparatuses is common at all levels of engraving, whether professional or hobbyist.

Traditionally, laser engraving apparatuses comprise a laser movable within a horizontal plane to permit the engraving of an object's surface positioned parallel to the horizontal plane. While horizontal engraving may be suitable for some designs, such as wall art or plaques, it is severely limited in the types and structure of objects that can be engraved.

Some advancements to laser engraving apparatuses permit the engraving of non-flat objects, such as cups and bottles. These improvements generally require the user to be knowledgeable in the art and use specialized attachments to their laser engraving apparatus. For example, rotary attachments were developed for simultaneously clasping and rotating said articles allowing a laser engraver to engrave text and/or graphics on the articles. However, use of rotary attachments requires users to correctly calibrate the attachment to ensure that each object is properly aligned to the apparatus during engraving. Further, horizontal engraving with rotary attachments often requires the use of grasping means on both ends of the article, adding bulk and size to the overall arrangement.

Thus, there remains a need for an improved laser engraving apparatus to permit non-horizontal engraving. More particularly, there is a need for a laser engraving apparatus with a laser positioned along a vertical axis to permit engraving.

### SUMMARY

This Summary is provided to introduce a selection of concepts in a simplified form that are further described below in the Detailed Description. This Summary is not intended to identify key features or essential features, nor is it intended to limit the scope of the claims included herewith.

Aspects of the present disclosure relate to a laser engraving apparatus including: a vertical gantry defining a vertical axis; a horizontal rail defining a horizontal axis; a laser head secured to the vertical gantry by a laser mount; a gripping device indirectly slidably coupled to the horizontal rail, the gripping device configured to selectively receive an object; a vertical motor in communication with the laser mount; and a rotational motor in communication with the gripping device.

Aspects of the present disclosure relate to a laser engraving apparatus, wherein the vertical motor is in mechanical communication with the laser mount to permit movement of the laser head along the vertical axis.

Aspects of the present disclosure relate to a laser engraving apparatus, wherein the rotational motor is in mechanical communication with the gripping device to permit rotational movement of the gripping device.

Aspects of the present disclosure relate to a laser engraving apparatus, wherein the gripping device is secured to the horizontal rail by a chuck mount configured to permit horizontal movement of the gripping device.

Aspects of the present disclosure relate to a laser engraving apparatus, wherein the gripping device is configured to tilt relative to the vertical axis.

Aspects of the present disclosure relate to a laser engraving apparatus, wherein a tilt motor is configured to control a tilt of the gripping device.

Aspects of the present disclosure relate to a laser engraving apparatus, wherein the gripping device is a chuck.

Aspects of the present disclosure relate to a laser engraving apparatus, wherein the chuck includes at least one interchangeable jaw.

Aspects of the present disclosure relate to a laser engraving apparatus, wherein the at least one interchangeable jaw is self-centering.

Aspects of the present disclosure relate to a vertical laser engraving apparatus including: a vertical gantry defining a vertical axis; a horizontal rail defining a horizontal axis; a laser head secured to the vertical gantry by a laser mount, the laser mount slidably coupled to the vertical gantry; a gripping device indirectly slidably coupled to the horizontal rail, the gripping device configured to selectively receive an object; a vertical motor in communication with the laser mount, the vertical motor configured to move the laser mount along the vertical gantry; a horizontal motor in communication with the gripping device, the horizontal motor configured to move the gripping device along the horizontal rail; a rotational motor in communication with the gripping device, the rotational motor configured to rotate the gripping device; and a tilt motor in communication with the gripping device, the tilt motor configured to tilt the gripping device.

Aspects of the present disclosure relate to a vertical laser engraving apparatus, wherein the tilt motor is configured to tilt the gripping device until a surface of the object is parallel to an axis of the vertical gantry.

Aspects of the present disclosure relate to a vertical laser engraving apparatus, wherein the surface of the object is parallel to the axis of the vertical gantry when a first point on the object is a first distance from the vertical gantry and a second point on the object is a second distance from the vertical gantry, and wherein the first distance and the second distance are equal.

Aspects of the present disclosure relate to a vertical laser engraving apparatus, wherein the gripping device includes a plurality of interchangeable jaws, wherein the plurality of interchangeable jaws are self-centering.

Aspects of the present disclosure relate to a vertical laser engraving apparatus, wherein the plurality of interchangeable jaws are centered about a gripping device axis running through the center of the gripping device, and wherein the plurality of interchangeable jaws is configured to engage the object so that the object is concentric with the gripping device axis.

Aspects of the present disclosure relate to a method of laser engraving an object with a vertical laser engraving machine, the method including: engaging the object with a gripping device; tilting the gripping device until an object surface is parallel to a vertical gantry of the laser engraving machine; moving the gripping device along a horizontal rail until the object surface is a predetermined distance from a laser head, the laser head slidably coupled to the vertical gantry; emitting a laser from the laser head, the laser configured to engrave the object; moving the laser head along the vertical gantry; and rotating the object about a gripping device axis.

Aspects of the present disclosure relate to a method, wherein the object surface is parallel to the axis of the vertical gantry when a first point on the object is a first distance from the vertical gantry and a second point on the object is a second distance from the vertical gantry, and wherein the first distance and the second distance are equal.

Aspects of the present disclosure relate to a method, wherein the gripping device includes a plurality of interchangeable jaws, wherein the plurality of interchangeable jaws are self-centering.

Aspects of the present disclosure relate to a method, wherein the plurality of interchangeable jaws are centered about the gripping device axis running through the center of the gripping device, and wherein the plurality of interchangeable jaws is configured to engage the object so that the object is concentric with the gripping device axis.

Aspects of the present disclosure relate to a method, the method further including entering inputting a series of commands into a processing unit, the processing unit configured to, based on the series of commands, control the tilting of the gripping device, the rotation of the gripping device, movement of the gripping device along the horizontal rail, the movement of the laser head along the vertical gantry, and an emission of the laser in order to engrave a predetermined pattern onto the object.

Aspects of the present disclosure relate to a method, wherein the method further includes adjusting a horizontal position of the gripping device based on a change in angle of the object surface.

Aspects of the present disclosure relate to a laser engraving apparatus including: a laser head slidably coupled to a vertical gantry, the laser head mechanically coupled to a vertical motor, wherein the vertical motor is configured to drive the laser head vertically upon the vertical gantry; a gripping device slidably coupled to a horizontal rail, the gripping device configured to selectively receive an object, the gripping device mechanically coupled to a rotational motor, wherein actuation of the rotational motor rotates the gripping device; a carriage block comprising a receiving member disposed on a bottom surface of the carriage block, the receiving member sized to partially surround a portion of the horizontal rail, the carriage block adapted to accept a lead screw, wherein the lead screw at least partially extends through the carriage block, wherein actuation of the lead screw induces movement in the carriage block along the horizontal rail; a chuck mount, defined as a vertical planar member, disposed on the carriage block, the chuck mount attached to a motor housing, the motor housing bearing the gripping device and the rotational motor; a working internal volume housing at least the laser head and the gripping device; a laser source disposed in a laser emission compartment, the laser emission compartment physically separated from the working internal volume, the laser source producing a laser, wherein said laser is directed to the laser head via one or more mirrors; a gantry support disposed along a length of the vertical gantry and affixed to a work surface, the gantry support comprising a gantry support aperture, wherein the laser traverses the gantry support aperture upon direction from the laser source to the laser head.

In accordance with one embodiment, a laser engraving apparatus comprises a vertical gantry, a laser head mounted to the vertical gantry, a horizontal rail, and a gripping device secured to the horizontal rail.

The laser head may be operative to move vertically along a vertical axis defined by the vertical gantry. In one embodiment, the laser head may be coupled to a vertical motor to permit the movement of the laser head along the vertical axis. In some embodiments, the vertical motor may be disposed within a motor housing secured to the vertical gantry by one or more mounting brackets.

The laser head may emit a laser parallel to a horizontal axis defined by the horizontal rail. It is contemplated that by moving the laser head along the vertical axis, the laser may be moved to create vertical scanning movement. More particularly, the laser may be moved in a vertical motion according to a prompt, such as a design, given to the vertical motor to permit the engraving of an object.

In one embodiment, the gripping device, such as a chuck, is configured as a mount for the object to be engraved. A person of ordinary skill will recognize that the “chuck” may be interchangeably referred to as a grip, carousel, or other gripping device.

The chuck may be configured to clamp to the object to be engraved in a position to permit the object to be positioned opposing the vertical axis to permit a laser from the laser head to contact the object to be engraved. In another embodiment, the chuck may be movable along the horizontal axis defined by the horizontal rail. It is contemplated that by permitting the chuck to move along the horizontal axis, the object may be moved horizontally towards and away from the vertical gantry.

In an embodiment, the chuck may be coupled to a horizontal motor to permit rotation of the object to engraved during use. For example, the horizontal motor may rotate the chuck about a rotational axis, thus rotating an object to be engraved that is mounted on the chuck.

In some embodiments, the chuck may be configured to tilt relative to the vertical axis. In another embodiment, the horizontal rail may extend off a horizontal plane at an angle to achieve a tilt in the object to be engraved relative to the vertical axis. It is contemplated that tilting the chuck may permit the object to be engraved to provide a surface substantially parallel to the vertical axis. For example, when the object to be engraved is a cup, or other similar object, a base, or any other portion, of the cup may be secured to the chuck and may extend vertically from the chuck. A person of ordinary skill will recognize that many cups comprise a tapered outer surface and it should be recognized that tilting the cup may create an engraving surface substantially parallel to the vertical axis. Of course, other objects to be engraved may be utilized, and the aforementioned are provided as nonlimiting examples only.

In an embodiment, the laser engraving apparatus may further comprise a tilt adjustment knob disposed on the chuck mount, wherein actuation of the tilt adjustment knob tilts the gripping device by an angle relative to the vertical gantry.

In an embodiment, the laser engraving apparatus may further comprise a horizontal adjuster disposed on the lead screw, wherein actuation of the horizontal adjuster moves the carriage block, and indirectly the gripping device, along the horizontal rail.

In an embodiment, the laser engraving apparatus may further comprise a tilt motor, wherein actuation of the tilt motor tilts the gripping device by an angle relative to the vertical gantry.

In an embodiment, the laser engraving apparatus may further comprising a horizontal motor in mechanical communication with the lead screw, wherein actuation of the horizontal motor moves the carriage block, and indirectly the gripping device, along the horizontal rail.

In an embodiment, the one or more mirrors may comprise a first mirror, a second mirror, and a head mirror, the first mirror and the second mirror disposed on a laser engraving floor, and the head mirror disposed on the laser head, wherein each of the first mirror, the second mirror, and the head mirror, alter the laser's direction by 90 degrees.

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 is an illustration of a vertical gantry laser engraving apparatus engraving a cup in accordance with one or more embodiments of the present disclosure.

FIG. 2A is an illustration of a vertical gantry laser engraving apparatus engraving a tumbler in accordance with one or more embodiments of the present disclosure.

FIG. 2B is an illustration of a vertical gantry laser engraving apparatus engraving a tumbler in accordance with one or more embodiments of the present disclosure.

FIG. 3 is an illustration of a vertical gantry laser engraving apparatus within a laser engraving housing in accordance with one or more embodiments of the present disclosure.

FIG. 4 is an illustration of a rear view of a vertical gantry laser engraving apparatus in accordance with one or more embodiments of the present disclosure.

FIG. 5 is an illustration of a vertical gantry laser engraving apparatus housing in accordance with one or more embodiments of the present disclosure.

FIG. 6 is an illustration of a vertical gantry laser engraving apparatus within a laser engraving housing in accordance with one or more embodiments of the present disclosure.

FIG. 7A is an illustration of a top-down view of a vertical gantry laser engraving apparatus in accordance with one or more embodiments of the present disclosure.

FIG. 7B is an illustration of a top-down view of a vertical gantry laser engraving apparatus in accordance with one or more embodiments of the present disclosure.

FIG. 8A is a left-front view of an illustration of a vertical gantry laser engraving apparatus with an engraving support structure in accordance with one or more embodiments of the present disclosure.

FIG. 8B is a left-rear view of an illustration of a vertical gantry laser engraving apparatus with an engraving support structure in accordance with one or more embodiments of the present disclosure.

FIG. 8C is a right-rear view of an illustration of a vertical gantry laser engraving apparatus with an engraving support structure in accordance with one or more embodiments of the present disclosure.

FIG. 9 is an illustration of a chuck used in a vertical gantry laser engraving apparatus in accordance with one or more embodiments of the present disclosure.

FIG. 10 is a close-up view of the chuck, chuck mount, and horizontal rail of FIG. 8A in accordance with one or more embodiments of the present disclosure.

FIG. 11 is a close-up view of the chuck engaged with an object of FIG. 1 in accordance with one or more embodiments of the present disclosure.

FIG. 12 illustrates a block diagram of an external computing device in communication with a vertical laser engraving apparatus in accordance with one or more embodiments of the present disclosure.

FIG. 13 illustrates a block diagram of an electronic device and accompanying processing system in accordance with one or more embodiments of the present disclosure.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

It is noted that description herein is not intended as an extensive overview, and as such, concepts may be simplified in the interests of clarity and brevity.

All documents mentioned in this application are hereby incorporated by reference in their entirety. Any process described in this application may be performed in any order and may omit any of the steps in the process. Processes may also be combined with other processes or steps of other processes.

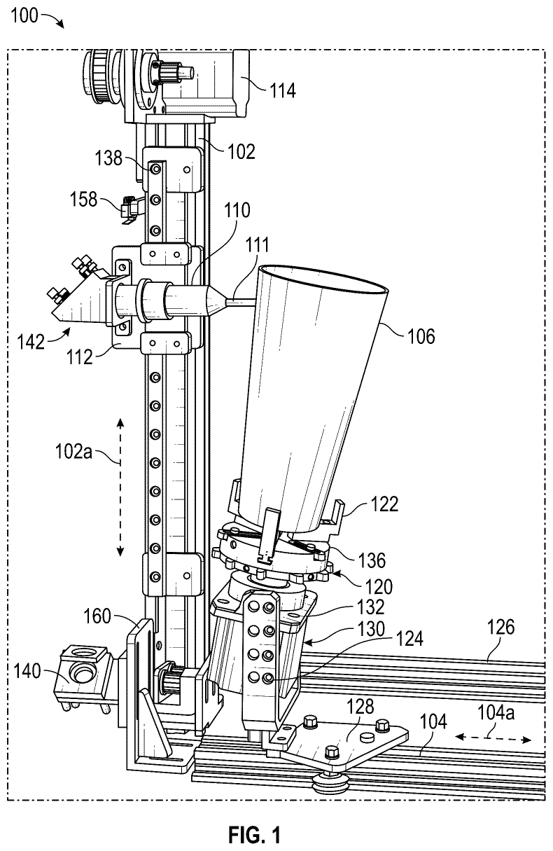

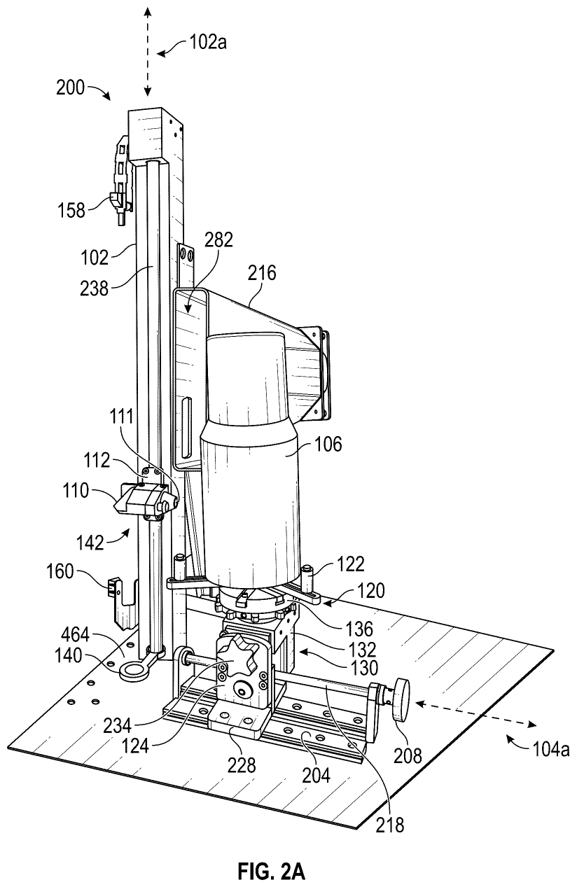

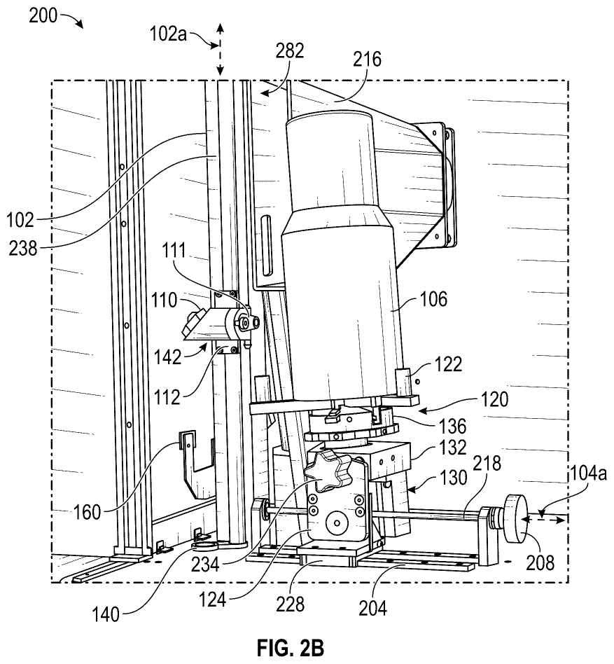

FIGS. 1, 2A and 2B illustrate one embodiment of a laser engraving apparatus 100, 200 comprising a vertical gantry 102 and a horizontal rail 104. The vertical gantry 102 may define a vertical axis 102a and the horizontal rail 104 may define a horizontal axis 104a. In some embodiments, the vertical gantry 102 may be removable and/or permanently secured to the horizontal rail 104. However, in another embodiment, the vertical gantry may be separate from the horizontal rail.

Returning to the embodiment in FIG. 1, a laser head 110 may be secured to the vertical gantry 102 by a laser mount 112 comprising one or more mounting brackets. A vertical motor 114 may be mechanically coupled to the laser mount 112 along the vertical gantry 102 to permit movement along the vertical axis 102a. The vertical motor 114 may, in some embodiments, be mounted directly to the vertical gantry 102, however, in other embodiments the motor may be located near the vertical gantry 102.

Returning to the embodiment illustrated in FIG. 1, the vertical motor 114 may be mechanically coupled to the laser mount 112 to permit movement of the laser head 110 along the vertical gantry 102 by turning the belt 238 coupled to the laser head 110 or by meshing with the vertical guide rail 138. The vertical motor 114 may be electronically coupled to a computing device where a user may input engraving information. The vertical gantry 102 may also include top stop 158 and bottom stop 160 configured to prevent the laser head from traveling beyond the desired range along the vertical axis 102a. In another embodiment, the computing device may be configured to prevent the vertical motor 114 from moving the laser head 110 outside of the desired range along the vertical axis 102a. Such a computing device may generate, or otherwise contain, digital instructions, which are processed and transmitted to the vertical motor 114 to control the laser head 110 movement, speed, directionality, and/or intensity.

The vertical motor 114 may be operative to move the laser mount 112, and thus the laser head 110, along the vertical gantry 102 to permit vertical movement of the laser 111. It is contemplated that the vertical movement of the laser 111, which may be referred to as “up/down scanning,” may permit the laser 111 to engrave a design on an object 106 to be engraved as desired. For example, the laser 111 may engrave a design on the object 106 based on the input engraving information. In some embodiments, the laser engraving apparatus 100 may be capable of converting an input engraving design intended to be used by a laser engraving machine for engraving flat objects and converting the design to be engraved onto a curved object.

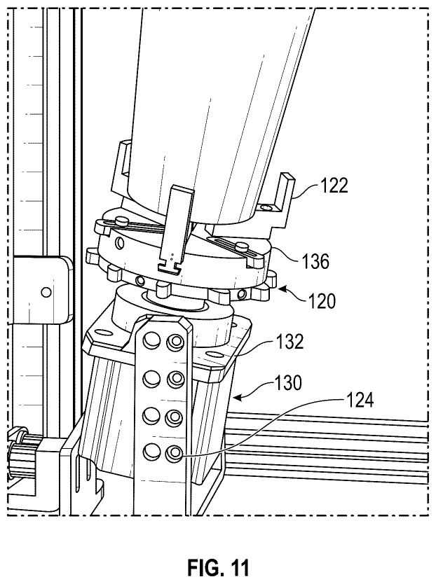

The horizontal rail 104, 204 may comprise a gripping device. The gripping device may be secured to the horizontal rail 104, 204 by a chuck mount 124. The chuck mount 124 may be movable along the horizontal rail 104, 204 and may support the gripping device. Such a configuration may be more easily seen in FIG. 11 which is a close-up view of the gripping device of FIG. 1.

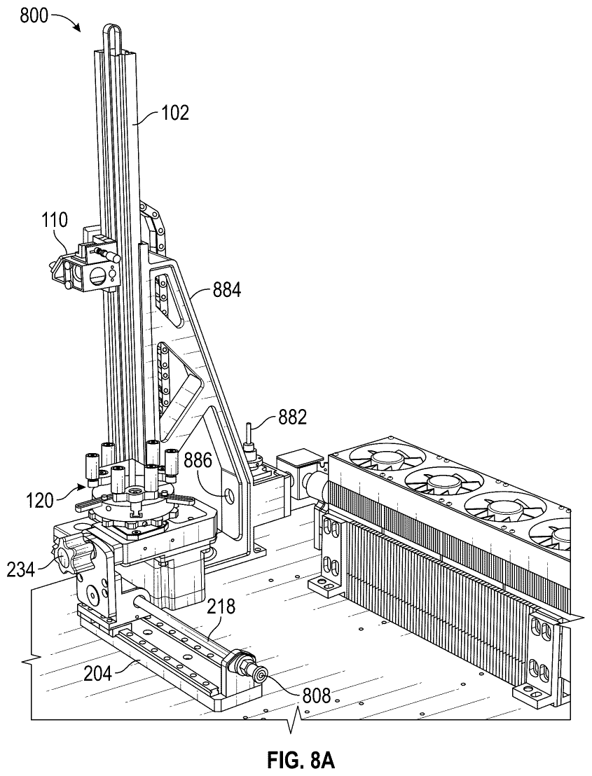

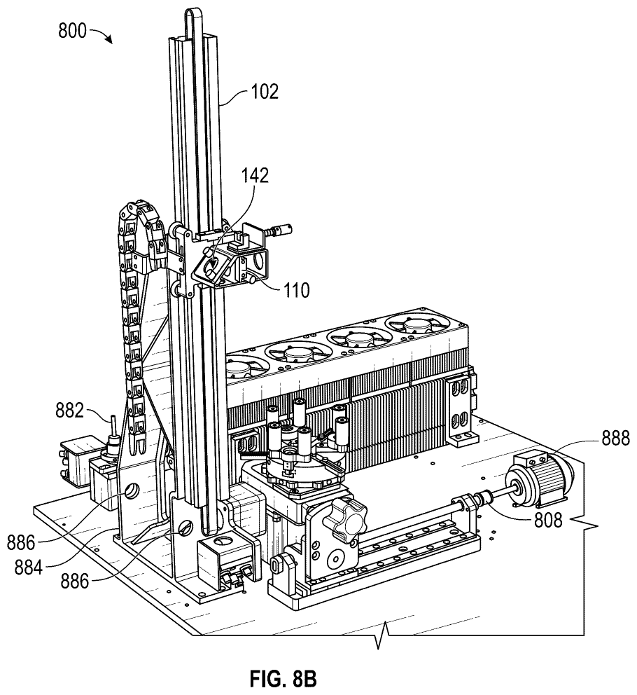

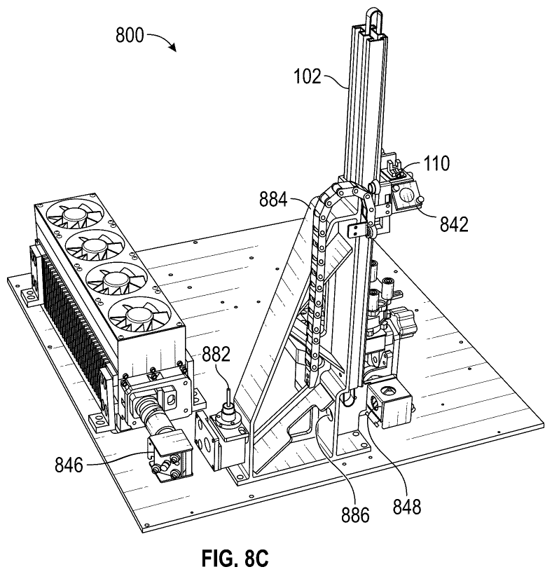

As shown in FIGS. 2A and 2B, in one or more embodiments, the laser engraving apparatus 200 may include a horizontal adjuster 208. The horizontal adjuster 208 may be statically coupled to a lead screw 218 configured to thread the chuck mount 124. In some embodiments, the horizontal adjuster 208 may be a hand wheel as shown in FIGS. 2A and 2B. In other embodiments, the horizontal adjuster 808 may be a wheel configured to be mechanically coupled to a horizontal motor 888 in order to automatically facilitate horizontal adjustment as shown in FIG. 8B. In one or more embodiments, the chuck mount 124 may be coupled to a carriage block 128, 228 configured to slide along the horizontal rail 104, 204. In other embodiments, the horizontal rail 104 may be replaced by, or used in conjunction with, an aligning bar or any other suitable means to guide the linear movement of the chuck mount 124. As the lead screw 218 is rotated by the horizontal adjuster 208, the chuck mount 124 and the carriage block 128, 228 may travel along the horizontal axis 104a allowing the distance between the object 106 and the laser head 110 to be adjusted. In other embodiments, the horizontal adjuster 208 may be replaced by a horizontal motor 888 configured to rotate the lead screw 218. In still other embodiments, the chuck mount 124 may include a horizontal motor configured to mesh with a guide rail 126 of the laser engraving apparatus 100. Actuation of the horizontal motor may allow the chuck mount 124 and carriage block 128, 228 to travel horizontally along the horizontal rail 104, 204. In still other embodiments, the horizontal motor coupled to the chuck mount 124 may be configured to mesh with a belt or gear train on the horizontal rail 104, 204 to provide horizontal movement to the chuck mount 124. In other embodiments, the horizontal motor may engage a rack and pinion gear. It is contemplated that any manual or motorized system may be utilized as long as the system is capable of moving the chuck mount 124 along the horizontal rail 104, 204. The gripping device 120 may be indirectly slidably coupled to the horizontal rail 104, 204, for example, where the gripping device 120 is attached to the chuck mount 124, the rotational motor housing 132, the carriage block 128, 228, and where one of the aforementioned is slidably attached to the horizontal rail 104, 204. Thus, a component (the chuck mount 124, the rotational motor housing 132, the carriage block 128, 228, or another suitable component) may ride along the horizontal rail, facilitating horizontal movement of the gripping device 120, since the gripping device is attached to said component.

It is contemplated that permitting movement along the horizontal rail 104, and thus the horizontal axis 104a, may permit the apparatus 100 to accommodate various sized objects 106. For example, bowls, tumblers, bats, cups, mugs, buckets, vases, and any other object that may be desired. Further, in some instances, the gripping device may be configured to permit the object to be positioned in a natural position, such as on a flat base portion of the object.

In the embodiment shown in FIG. 1, the gripping device may be configured as a chuck 120. It is contemplated other gripping devices may be utilized, such as a carousel, suction device, magnet, or grip. In various embodiments, the gripping device is capable of firmly holding and manipulating the object during the engraving process. In an alternate embodiment, the gripping device may be a platter or other surface, wherein the object rests upon the platter or other surface, and wherein, optionally, an external fastening means may reversibly attach the object to the platter or other surface. While the holding mean may be referred to as chuck throughout this disclosure, it should be understood that any form of gripping device may be used.

The chuck 120 may be configured to removably receive an object 106 to be engraved. In some embodiments, the chuck 120 may be configured to frictionally engage with the object 106 to be engraved and position the object 106 relative to the laser head 110. More particularly, in some embodiments, the object 106 may extend vertically from the chuck 120 positioned along the vertical axis 102a. As such, the laser 111 extending from the laser head 110 may be perpendicular to a surface of the object 106 extending vertically from the chuck 120 to permit engraving. In other embodiments, the chuck 120 may hold the object 106 at an angle. Such an embodiment may be desirable when the object 106 has angled sides as shown in FIG. 1. Tilting the chuck 120 to an angle corresponding to the angle of the sides of the object 106 may allow the surface of the object 106 in contact with the laser 111 to be parallel to axis 102a and therefore parallel to the vertical gantry 102. In a further embodiment, the angle of the chuck 120 may be controlled through the operation of a tilt adjustment knob 234 as shown in FIGS. 2A and 2B. In an alternate embodiment, the chuck 120 may be operatively coupled to a tilt motor configured to adjust the angle of the chuck 120. In such an embodiment, the tilt motor may be in communication with a processor configured to receive either an input angle from a user or a three dimensional rendering of the object 106 in which the processor is capable of analyzing to determine the appropriate tilt angle of the chuck 120 to ensure the surface of the object 106 in contact with the laser 111 is parallel to the vertical axis 102a. In another embodiment, the laser engraving apparatus may be capable of measuring the distance from the laser head 110 to the object 106. Such measurements may be accomplished through an optical measuring device coupled to the vertical gantry 102. In another embodiment, the optical measurement device may be coupled directly to the laser head 110. In such an embodiment, a first distance between the laser head 110 and a first point on the object 106, such as the bottom of the object 106, may be compared to a second distance between the laser head 110 and a second point on the object 106, such as the top of the object 106. The chuck 120 may then be manually or automatically tilted until the first distance and the second distance are equal to ensure the object surface to be engraved is parallel to the vertical gantry 102. In a further embodiment, the laser engraving apparatus 200 may determine that the object 106 to be engraved has two or more portions, each portion with varying radii and/or taper angles such as the object 106 depicted in FIGS. 2A and 2B. In such an embodiment, the laser engraving apparatus 200 may identify a top portion having a first radius and/or taper angle, a transition portion having a second radius and/or taper angle, and a bottom portion having a third radius and/or taper angle. The laser engraving apparatus 200 may determine, for each of the portions, a first point to measure a first distance to the laser head 110 and a second point to measure a second distance to the laser head 110. The laser engraving apparatus 200 may then determine an appropriate tilt angle and object distance from the vertical gantry 102 for each of the portions to be engraved. While an object 106 with three portions is illustrated and described herein, it is contemplated that an object 106 may also have two, four, or any number of portions. In another embodiment, a user may manually input a specified angle to tilt the chuck 120. This specified angle may correspond to a taper angle of the object 106 to be engraved. In still other embodiments, one or more presets may be input to set the chuck 120 at a specified tilt and/or distance from the laser head 110. For example, a plurality of objects may need to be engraved, and each object in the plurality of object may form to either shape A or shape B. Shape A may describe an object with a 15° taper, a 2.5-inch base radius, and a 3.5-inch top radius while shape B may describe an object with a 0° taper and a 15-inch radius. Inputting preset A may automatically tilt the object to 15°, making the object's surface parallel to the vertical axis 102a and horizontally adjusting the object so that the object's parallel surface is an optimal focusing distance from the laser head 110. Inputting preset B may automatically tilt the object to 0°, making the object's surface parallel to the vertical axis 102a and horizontally adjusting the object so that the object's parallel surface is an optimal focusing distance from the laser head 110. Any number of presets may be included to describe any number of objects with various tapers and radii.

In one or more embodiments, the chuck 120 may comprise at least one interchangeable jaw 122 coupled to at least one grip head 136 and a plurality of adjustable alignment stoppers. The at least one interchangeable jaw 122 may be configured as an L-jaw, a post, or any other suitable configuration. The at least one interchangeable jaw 122 may be comprised of a rigid material. The at least one interchangeable jaw 122 may be self-centering to ensure consistent placement of the object 106 on the grip head 136. In one embodiment, the at least one interchangeable jaw 122 may be configured to secure the object 106 to the chuck 120. It should be understood that other chuck designs may be contemplated, and any chuck design may be used as long as the chuck design is capable of holding the object 106 in such a way sufficient to be etched/engraved. Furthermore, the chuck design may include a turntable having multiple chucks, each capable of holding an object to be engraved. In such an embodiment, it may be desirable to have the turntable capable of both tilt and rotation. It may also be desirable to have each of the individual chucks on the turntable to be capable of both tilting and/or rotation. The turntable may be designed with multiple chucks, each capable of securely holding an individual object for laser engraving. The entire turntable may be rotatable, enabling each chuck to sequentially move into proximity with the vertical gantry of the laser engraving apparatus. This rotation mechanism allows for multiple objects to be loaded onto the apparatus at once, enhancing efficiency by eliminating the need to load objects individually. Once the turntable is positioned, the laser engraver processes each object in turn, ensuring precise engraving on each item without user intervention during the engraving process.

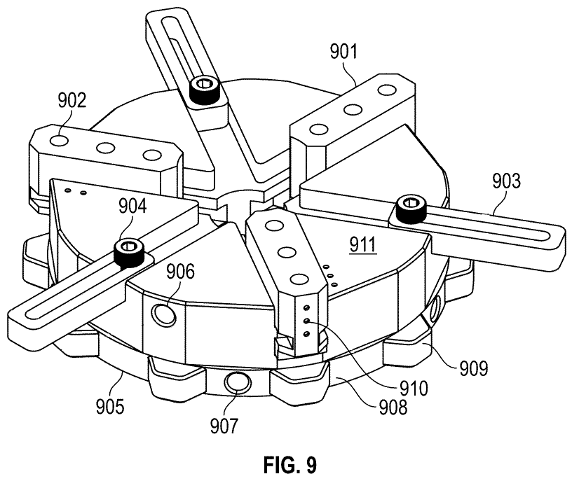

Referring to FIG. 9, in an embodiment, the chuck housing 911 may be further comprised of at least one self-centering jaws base 901 and/or a scroll wheel 905. The at least one self-centering jaws base 901 may be disposed upon the chuck housing 911. In a nonlimiting example, a channel(s) may be formed within a face of the chuck housing 911, wherein said channel(s) is configured to house the at least one self-centering jaws base 901. In such a nonlimiting example, the at least one self-centering jaws base 901 may have at least one channel hole 910, wherein said channel hole 910 may correspond to the channel the at least one self-centering jaws base 901 is to be housed within. In an embodiment, the at least one self-centering jaws base 901 and the scroll wheel 905 are in mechanical communication, such that rotational actuation of the scroll wheel 905 may translate to linear motion of the at least one self-centering jaws base 901. As a nonlimiting example, the linear motion of the at least one self-centering jaws base 901 may move towards a center of the chuck housing 911 via clockwise rotational actuation of the scroll wheel 905. In a further nonlimiting example, the linear motion of the at least one self-centering jaws base 901 may move away from a center of the chuck housing 911 via counterclockwise rotational actuation of the scroll wheel 905. However, the at least one self-centering jaws base 901 may move away from or towards the center of the chuck housing 911 via either clockwise or counterclockwise actuation of the scroll wheel 905. In an embodiment, each of the at least one self-centering jaws base 901 are configured to move in tandem, such that actuation of scroll wheel 905 imparts equal movement in each of the at least one self-centering jaws base 901.

The scroll wheel 905 may be comprised of a plurality of grooves 908 and/or a plurality of protrusions 909. In an embodiment, the plurality of grooves 908 and/or the plurality of protrusions 909 may allow for a user's fingers to comfortably grip the scroll wheel 905. Such a grip may enable the user to rotationally actuate the scroll wheel 905, wherein said rotational actuation translates to linear motion of the at least one self-centering jaws base 901. In an embodiment, each of the protrusions 909 may extend beyond the circumference of the chuck housing 911 and/or each of the grooves may be positioned in line with or shallower than the circumference of the chuck housing 911. Thus, the protrusions 909 may extend outside the edge of the scroll wheel 905 and allows the operator's fingers to hold securely and rotate the scroll wheel 905. Such an arrangement promotes adequate manipulation by a user's digits from a number of angles, permitting the at least on self-centering jaws base 901 to include any suitable jutting components or angular jaws without preventing the user from operating the scroll wheel 905.

In another embodiment, the chuck housing 911 may be further comprised of a chuck housing lever hole 906 and/or a scroll wheel lever hole 907 (collectively the “holes”). The holes may be in mechanical communication with the at least one self-centering jaws base 901. In an embodiment, the holes may be configured to receive a tool. In such an embodiment, when the tool is received by at least one of the chuck housing lever hole 906 and the scroll wheel lever hole 907, rotational actuation of the tool may result in linear motion of the at least one self-centering jaws base 901. The holes may provide the user with a second way to adjust the at least one self-centering jaws base 901.

The at least one self-centering jaws base 901 may be configured to accept the interchangeable jaws 122. In an embodiment, the interchangeable jaws 122 reversibly couple with the at least one self-centering jaws base 901. In such an embodiment, rotational actuation of the scroll wheel 905 enables a user to adjust the interchangeable jaws 122, via the linear motion of the at least one self-centering jaws base 901. In one embodiment, clockwise rotation of the scroll wheel 905 may cause the one or more jaws bases 901 to move in a first direction (e.g., away from the center of the chuck housing 911) and counterclockwise rotation of the scroll wheel 905 may cause the one or more jaws bases 901 to move in a second direction (e.g., toward the center of the chuck housing 911). However, the apparatus may be configured such that the scroll wheel 905 may be rotated in either direction to impart any desired movement in the one or more self-centering jaws bases 901. The adjustment of the interchangeable jaws 122 may allow for users to accommodate articles of various sizes, which may prevent the user from having to change the type of jaws utilized while laser engraving. Further, the adjustment of the interchangeable jaws 122 may obviate a need for further tooling, which may encourage increased storage space for the user. The at least one self-centering jaws base 901 may be comprised of at least one jaws hole 902. In an embodiment, the at least one jaws hole 902 is threaded. In such an embodiment, the interchangeable jaws 122 may reversibly couple with the at least one jaws hole 902 via a threaded connection. However, the at least one jaws hole 902 and the interchangeable jaws 122 may interface via any suitable means. In an alternative embodiment, the at least one jaws hole 902 may consist of three holes. In such an embodiment, the three holes may provide a user with the ability to customize a configuration of the interchangeable jaws 122 with the at least one self-centering jaws base 901.

The plurality of adjustable alignment stoppers 903 may be disposed upon the chuck housing 911. In a nonlimiting example, the plurality of adjustable alignment stoppers 903 may be disposed within a channel of the chuck housing 911, wherein said channel is sized to accept one or more of the plurality of adjustable alignment stoppers 903. In an embodiment, the plurality of adjustable alignment stoppers 903 may be further comprised of an alignment screw 904. In another embodiment, the alignment screw 904 may be threaded. The plurality of adjustable stoppers 903 may be comprised of a stopper channel. In a further embodiment, the alignment screw 904 may be disposed within the stopper channel. In such an embodiment, tightening the alignment screw 904 may lock the plurality of adjustable alignment stoppers 903 in a fixed position, and/or loosening the alignment screw 904 may unlock the plurality of adjustable alignment stoppers 903 allowing said stoppers 903 to move linearly.

The alignment screw 904 may be configured to keep the plurality of adjustable stoppers 903 in at least one of a locked position and an unlocked position. Said linear movement of the plurality of adjustable alignment stoppers 903 may enable the user to increase a contact surface area between the article and the headboard. In one embodiment, each of the plurality of stoppers 903 may move independently of one another. Thus, for example, each of the plurality of adjustable stoppers 903 may have independent movement, wherein each of the interchangeable jaws 122 may have tandem movement. The increased contact surface area between the article and the headboard may ensure a central axis of the article is aligned with a central axis of the headboard, wherein the alignment may provide a more even and/or stable surface for laser engraving of the article. As a nonlimiting example, the plurality of adjustable alignment stoppers 903, may be unlocked, allowing a user to adjust said stoppers 903 to at least one of an extended position and a non-extended position. In such a nonlimiting example, an article, secured by the interchangeable jaws, may have a circumference greater than that of the face of the chuck housing 911, the plurality of adjustable alignment stoppers 903 may be configured into an extended position, allowing for said stoppers 903 to come into contact with the article. Such interchangeability of positions of the plurality of adjustable alignment stoppers 903 may allow for a user to secure articles larger than the face of the chuck housing 911.

In an embodiment, the apparatus comprises at least three self-centering jaws bases 901. However, the apparatus may include any suitable number of self-centering jaws bases 901. For example, the apparatus may include three, four, or five self-centering jaws bases 901. In various embodiments, the apparatus may include a number and/or configuration of channels or stoppers 903 or any chuck housing configuration enabling utilization of the desired number of self-centering jaws bases 901. For example, in an embodiment with four self-centering jaws bases 901, the plurality of channels may be structured to house the four self-centering jaws bases 901, for example, such that each of the plurality of self-centering jaws bases 901 are disposed radially equidistant from one another. In various embodiments, regardless of the number of self-centering jaws bases 901, each of the self-centering jaws bases 901 may embody any of the configurations described herein. Further, each of the self-centering jaws bases 901 may accept any configuration of interchangeable jaws 122.

In one embodiment, the chuck 120 may be permitted to rotate about an axis to permit the object 106 to be rotated to contact the laser emitted from the laser head 110. In an embodiment, the chuck 120 may be mechanically coupled to a rotational motor 130 electronically coupled to the computing device. It is contemplated that a user may input a desired spin rate and/or spin direction of the chuck 120 into the computing device, wherein said input is electronically translated to the rotational motor 130, resulting in rotational actuation. Of course, other methods may be utilized to control the rotation of the chuck 120 and the aforementioned are provided as a nonlimiting example only. It is contemplated that the combination of the vertical movement of the laser 111 and the rotation of the object 106 caused by the rotation of the chuck 120 may allow the laser engraving apparatus to engrave or etch a two-dimensional design onto the curved surface of the object 106. It is further contemplated that the addition of the horizontal movement of the object 106 along the axis 104a may allow the laser engraving apparatus 200 to engrave an object 106 having an uneven, curved, or otherwise non-uniform surface such as the object shown in FIGS. 2A and 2B.

Another advantage of a rotary design as described in the embodiments herein is that there is no limit in movement of the rotational direction. A typical horizontal gantry is designed to etch an object within a two-dimensional plane consisting of the X-direction and the Y-direction. The horizontal gantry would only be able to move a certain amount of distance in both in X-and Y-directions before reaching the limit of the laser's range. However, in a vertical gantry capable of utilizing rotational motion, the limits to the Y-direction are removed. This is thanks to the fact the object can be rotated infinitely, and there is no possibility for the laser to move too far in the Y-direction.

In an embodiment, the chuck mount 124 may be further configured to secure and support a rotational motor housing 132 comprising the rotational motor 130. In one embodiment, the rotational motor housing 132 may be secured to the chuck mount 124 by at least one mounting screw. In some embodiments, the at least one mounting screw may be threaded. In such an embodiment, the at least one mounting screw may comprise at least one tilt screw and at least one vertical lock screw. It is contemplated that the tilt screw may permit the chuck 120 to tilt relative to the vertical axis 102a. In other embodiments, any other configuration may be used to adjust the tilt of the chuck 120. It is contemplated that tilting the chuck 120 may permit the object 106 to be engraved to provide a surface substantially parallel to the vertical axis 102a.

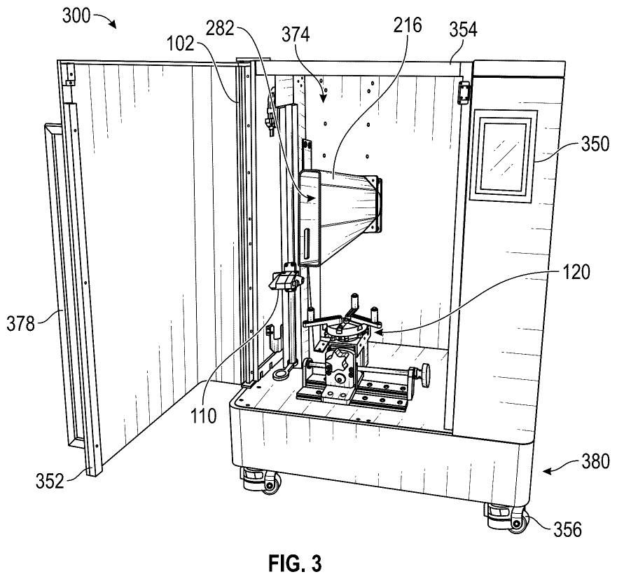

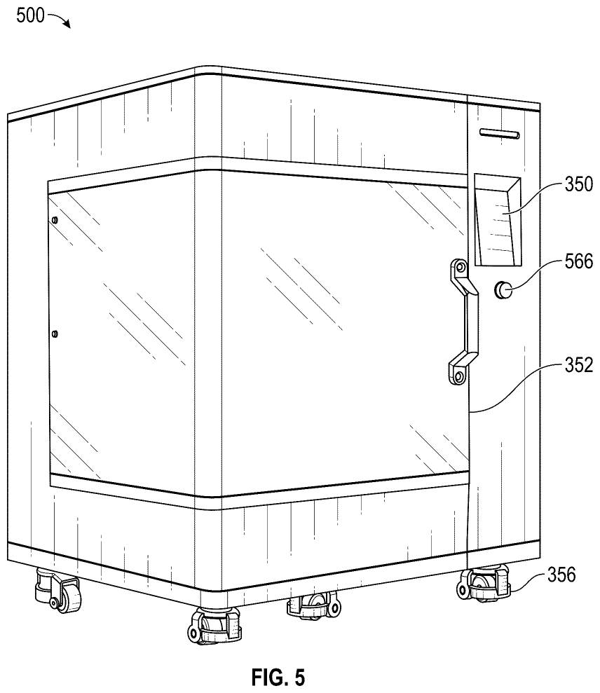

Referring now to FIGS. 3, 5, and 6, the laser engraving apparatus 300, 500, 600 may include a laser engraving housing 354 configured to house all of the components described herein within a working internal volume 374. In some embodiments, the laser engraving housing 354 may include a control screen 350 configured to receive inputs relating to the process of laser engraving an object 106 including, but not limited to, manually moving the laser axis (Jog), setting Jog speeds and step lengths, setting Jog movement to continuous or in steps, loading a file from memory where the file may have a predetermined pattern to be etched, deleting said files, loading a file from a USB device, editing file settings such as speed and power, changing settings (i.e., IP address, default laser power, etc.), framing the engraving to indicate where the engraving will go (i.e., rotating/tilting the object or moving the laser head), setting an origin to tell the engraving machine where to start, setting the manual-or auto-focus (i.e., moving the chuck further from or closer to the laser), START/STOP/PAUSE, test firing the laser, dimensional inputs, date/time, and the like. In other embodiments, some or all of these settings may be controlled from an external computer or processor. The laser engraving housing 354 may include a lever or button 566. The button may be configured to START/STOP the laser engraving process, particularly in an emergency situation. In another embodiment, an emergency START/STOP button may be separate from any buttons providing general control or input functionalities. The laser engraving housing 354 may include a door 352 and door handle 378. The door 352 may have an open state, as shown in FIG. 3, and a closed state, as shown in FIG. 5. While the door 352 is in the open state, the working internal volume 374 may be accessible. The door 352 may include a lock 668 to prevent the door 352 from unintentionally opening. The laser engraving housing 354 may include a sensor in electrical communication with the controller of the laser engraving apparatus 300. The sensor may be capable of determining whether the door 352 is in the open state or the closed state. In one or more embodiments, upon the sensor determining the door to be in the open state, the controller may prevent the laser engraving apparatus from performing any engraving/etching or positioning functions in order to protect the device and/or a user from accidental damage or injury. In such an embodiment, upon the sensor determining the door to be in a closed state, the controller may allow the laser engraving apparatus 300 to perform engraving/etching or positioning functions. The laser engraving housing 354 may include feet or wheels 356. The feet or wheels may provide for a surface with increased and/or decreased friction for the laser engraving apparatus 300 to rest upon. The feet or wheels 356 may be individually height adjustable so that the laser engraving apparatus may be made level on an uneven surface. The wheels 356 may include locks to prevent any undesired movement of the laser engraving apparatus 300.

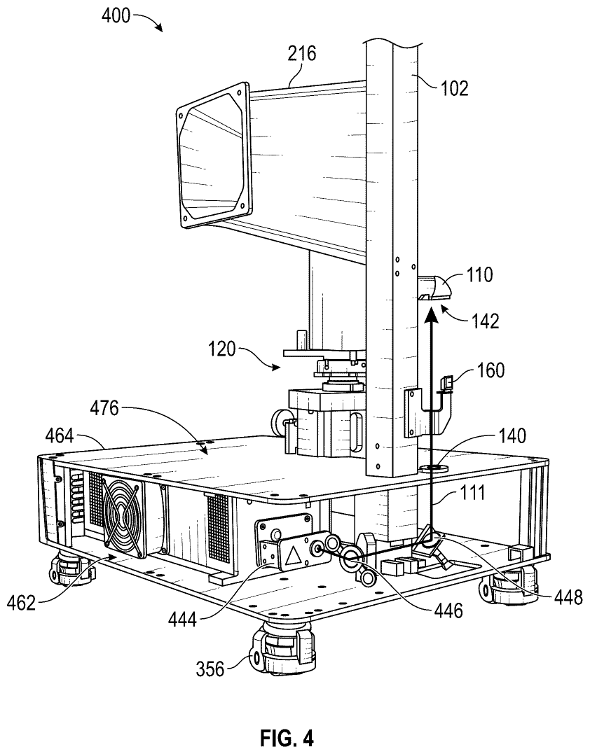

FIG. 4 illustrates a rear view of one or more embodiments of a laser engraving apparatus 400 comprising a laser emission compartment 462. The laser emission compartment 462 may be housed within a lower portion 380 of the laser engraving housing 354 beneath the laser engraving base 464. The emission compartment 462 may comprise the space below the laser engraving floor 476 and house the radiofrequency (RF) laser tube 444. It should be understood that any laser type may be used, and that the present disclosure is not limited to RF laser technology. The RF laser tube 444 may emit a laser 111 capable of engraving/etching an object. In some embodiments, the laser 111 may be directed directly at an object to be engraved/etched. In other embodiments, the laser 111 may be redirected through the use of various mirrors and/or focused using lenses. As shown in FIG. 4, the RF laser tube 444 may emit a laser 111 toward a first mirror 446. Upon striking the first mirror 446, the laser 111 may alter its trajectory, for example, ninety (90) degrees, in order to strike the second mirror 448. Upon striking the second mirror 448, the laser 111 may alter its trajectory, for example, ninety (90) degrees, in order to pass through the clear window 140 in the laser engraving floor 476. As the laser 111 continues through the clear window 140, the laser 111 may continue until the laser strikes the laser head 110. The laser head 110 may comprise a head mirror 142 that directs the laser ninety (90) degrees through a focusing lens before striking the object 106.

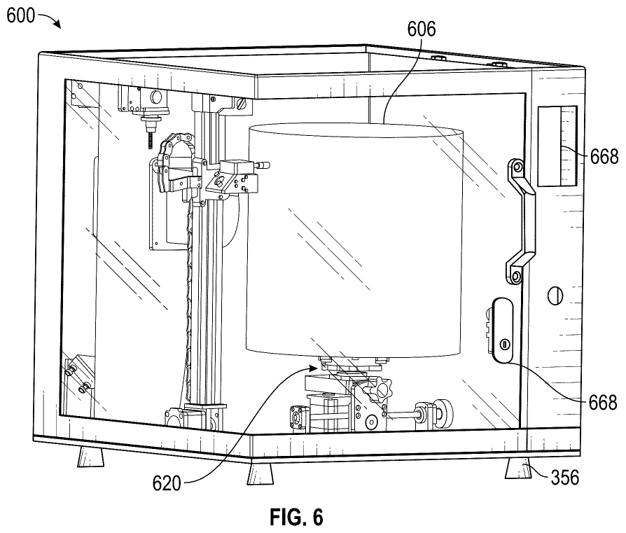

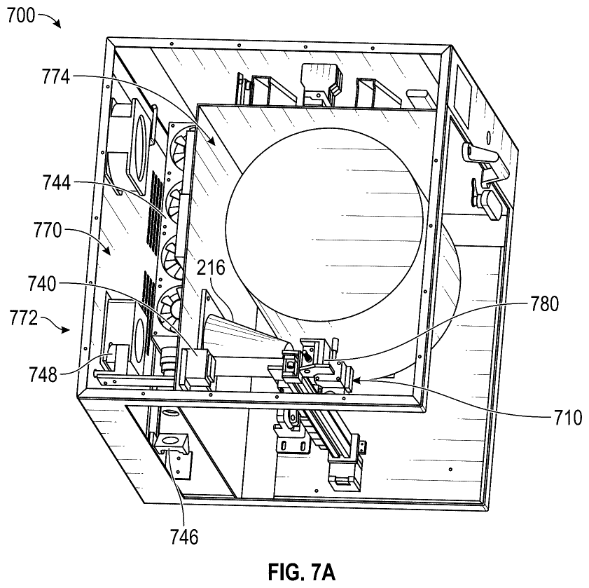

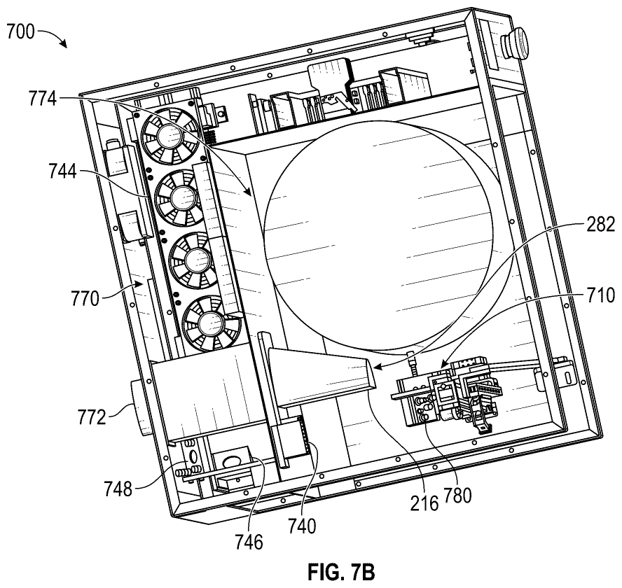

Referring now to FIGS. 6, 7A, and 7B, a laser engraving apparatus 600, 700 configured to engrave/etch a large object 606, such as a bucket, is shown. In one or more embodiments, the laser emission compartment 770 may reside behind the working internal volume 774. In such an embodiment, the RF laser tube 744 may emit the laser 111 toward a first mirror 746. The first mirror 746 may then redirect the laser 111 ninety (90) degrees to strike the second mirror 748. The second mirror 748 may then direct the ninety (90) degrees to travel through the clear window 740 before striking a third mirror 780. The third mirror 780 may then direct the laser 111 ninety (90) degrees downward to strike the laser head 710. The laser head 710 may include a head mirror that directs the laser ninety (90) degrees through a focusing lens before striking the object 606 with enough intensity for engraving/etching. The present disclosure should not be limited to any particular allocation and/or arrangement of mirrors and lenses. Any number of mirrors and lenses may be used and positioned in various ways as long as the laser strikes the object with sufficient intensity. In another embodiment, the laser source may be within the laser head 110, eliminating the need for mirrors to redirect the laser 111 to the laser head 110. In such an embodiment, it may or may not be necessary to also include a focusing lens in the laser head 110. In such an embodiment where the laser source resides within the laser head 110, a diode laser may be used. Various types of lasers are contemplated herein. For example, a galvo and fiber laser may be utilized. In such an embodiment, light from the laser may be transmitted through fiberoptic cables to the galvo laser head. These fiberoptic cables may also amplify the laser. A galvo head may have two galvanometer motors that rotate small mirrors, directing light into a large F-Theta Scan Lens that straightens and focuses laser beams on the engraving surface. In another example, a separate CO₂ laser source with a mirror solution as described above may be used. It is contemplated that any type of laser may be used to engrave the object.

For large objects such as buckets, the chuck 620 may be inserted into an opening of the object 606. Once the chuck 620 has been inserted, the jaws may then expand radially until the jaws are in contact with the object 606 in such a way as to create substantial frictional force so that the object 606 is secured to the chuck 620. Further, the vertical orientation may allow for taller or top-heavy objects to be engaged with the chuck without the need for compensating for significant leverage forces as opposed to a horizontal orientation. When an object is placed vertically or nearly vertically, the object's center of gravity resides directly above or nearly directly above the base of the object being secured by the chuck. Such a configuration may reduce the amount of leverage force experienced by the object and therefore reduce the amount of support needed to hold the object in place. On the other hand, a horizontal orientation would create the maximum amount of leverage force an object could experience. Due to this high leverage force, it is often necessary to provide support to the other end of the object as well while in a horizontal orientation.

Another advantage of a laser engraving machine having a vertical orientation is a reduced footprint compared to a laser engraving machine having a horizontal orientation. A horizontal laser engraving machine requires significantly more space in the horizontal direction in order to provide the laser head with horizontal movement along the entire height of an object in a horizontal orientation. On the other hand, a vertically oriented engraving machine only needs enough horizontal space to move the object being engraved up against the laser head. Therefore, the horizontal movement needed from the vertically oriented engraving machine is significantly less compared to the horizontally oriented engraving machine. Such a reduced footprint of the vertically oriented engraving machine may allow the vertically oriented engraving machine to be more compact, mobile, and versatile regarding the surface the engraving machine could be placed on such as a smaller desk or table compared to a desk or table required to support the horizontally oriented engraving machine.

FIGS. 7A and 7B further illustrate the use of an exhaust duct 216. As the laser 111 removes material from the object through engraving/etching, fumes and debris may accumulate within the working internal volume. The exhaust duct 216 may be configured to remove any accumulated fumes and debris from the engraving/etching process in order to keep the object clean and clear of any obstructions. The exhaust duct may comprise an inlet 282. As shown in FIGS. 2A and 2B, the inlet 282 may be located near the laser head 110 and shaped so to cover most of, if not all, possible locations the laser 111 may strike the object 106, 606. The exhaust duct 216 may further include an outlet 772 to exhaust the accumulated fumes and debris to the exterior of the laser engraving apparatus 700. The outlet 772 may include an exhaust fan configured to extract any accumulated fumes and debris into the inlet 282, through the exhaust duct 216, and then out the outlet 772.

FIGS. 8A-8C illustrate a laser engraving apparatus 800 having a gantry support 884 in accordance with one or more embodiments of the present disclosure. During use of a laser engraving machine, stability issues may arise causing the laser head 110 to experience unintentional movement during the etching/engraving process. The inclusion of the gantry support 884 may reduce or eliminate such unintended movement. As shown in FIGS. 8A-8C, the gantry support 884 may include various bars connecting at various angles and supporting the vertical gantry 102 in various locations. However, it should be understood that any gantry support design capable of reducing or eliminating unintended movement may be utilized. The gantry support 884 may also include one or more gantry support aperture 886. In the event the gantry support 884 resides in the path of the laser, the gantry support aperture 886 may allow the laser to continue on its desired path without hindrance.

Also shown in FIGS. 8A-8C is a guiding diode 882. In one or more embodiments, the guiding diode may emit a beam of light that follows the path of the laser 111. This guiding diode 882 may be used to “aim” the laser or determine where the laser will etch the object without having to turn on the laser. As the beam from the guiding diode 882 follows the laser's path, the beam may pass through the laser head 110 and strike the object 106 at the exact location the laser 111 would strike the object 106 when the laser 111 is activated.

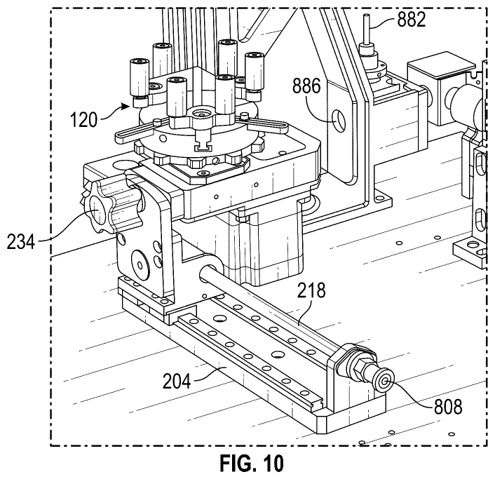

FIGS. 8A-8C also illustrate another embodiment of the gripping device and chuck mount. A magnified view of FIG. 8B can be found in FIG. 10. FIG. 10 depicts a chuck 120 or gripping device with a tilt adjustment knob 234. The griping device is also shown to be slidably coupled to the horizontal rail 204. The carriage block 128, 228 may include a receiving member disposed on the bottom surface of the carriage block 128, 228, wherein said receiving member at least partially surrounds a portion of the horizontal rail 104, 204, wherein said portion comprises a cross-sectional profile sized to slidably interface with the receiving member of the carriage block 128. 228. In an embodiment, when the carriage block 128, 228 interfaces with both the horizontal rail 204 and the lead screw 218, the centroid of the rotational motor housing 132 may be adequately supported, despite the weight of the rotational motor housing 132, gripping device, and rotational motor 130 being positioned on the side of the horizontal rail 204 nearer to the laser head 110.

As shown in FIG. 8C, the laser tube may emit a laser 111 toward a first mirror 846. Upon striking the first mirror 846, the laser 111 may alter its trajectory, for example, ninety (90) degrees, but within a horizontal plane, in order to strike the second mirror 848. Upon striking the second mirror 848, the laser 111 may alter its trajectory, for example, ninety (90) degrees but within a vertical place. As the laser 111 continues upward, the laser 111 strikes the laser head 110. The laser head 110 may comprise a head mirror 842 that directs the laser ninety (90) degrees through a focusing lens before striking the object 106 in a horizontal plane. The first mirror 846 may direct the laser 111 through the gantry support aperture 886 to the second mirror 848. The first mirror 846 and the second mirror 848 may be disposed on the laser engraving floor. The head mirror 842 may be disposed on the laser head 110.

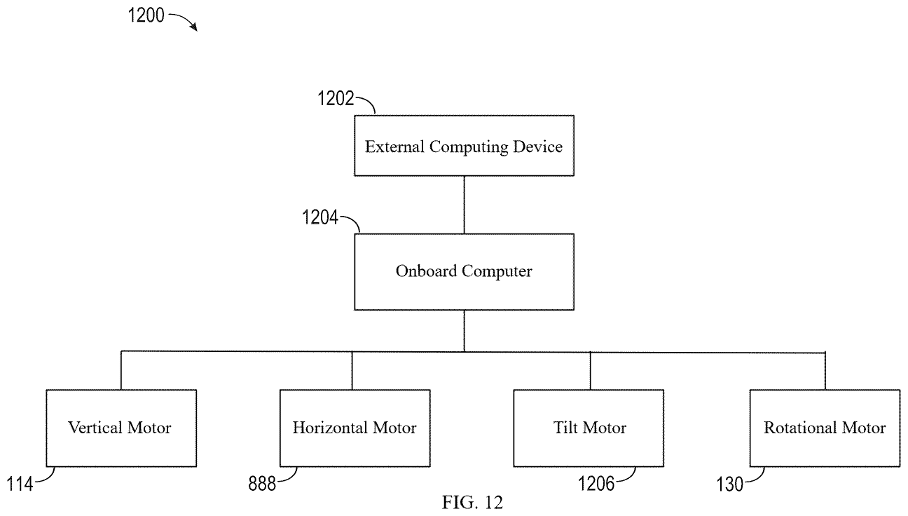

FIG. 12 illustrates a block diagram 1200 of an external computing device 1202 in communication with a vertical laser engraving apparatus in accordance with one or more embodiments of the present disclosure. Shown is an external computing device 1202 in communication with an onboard computer 1204 or processor of the vertical laser engraving apparatus. For the purposes of this disclosure, the functionality described herein with respect to the onboard computer 1204 may be accomplished, supplemented, and/or replaced by the control screen 350. The external computer 1202 may be a desktop, laptop, mobile device, or other computing device capable of executing programs for laser engraving instruction. Accordingly, the external computer 1202 may be capable of receiving inputs that include instructions to be interpreted by the onboard computer 1204 into a pattern or design to be engraved onto an object. Such instructions may be passed along to the onboard computer 1204, initiating the actuation of the lasers and motors to facilitate the given task. In other embodiments, the vertical laser engraving apparatus may function without the external computing device 1202. In such an embodiment, the instructions may be input or stored directly to the onboard computer 1204. In one or more embodiments, upon interpreting the instructions, the onboard computer 1204 may execute the instructions by controlling the vertical motor 114, horizontal motor 888, tilt motor 1206, and/or rotational motor 130. In other embodiments, there may be more or less motors controlled by the onboard computer 1204. In one embodiment, the apparatus may include the vertical motor 114 and the rotational motor 130, for example, wherein the apparatus includes manual horizontal and manual tilt controls. In another embodiment, the apparatus may include the vertical motor 114, the horizontal motor 888, and the rotational motor 130, for example, wherein the apparatus includes manual tilt controls. In another embodiment, the apparatus may include the vertical motor 114, the tilt motor 1206, and the rotational motor 130, for example, wherein the apparatus includes manual horizontal controls. In another embodiment, the apparatus may include the vertical motor 114, horizontal motor 888, tilt motor 1206, and/or rotational motor 130, for example, wherein each of the four corresponding controls and actuated via motor with the aforementioned motors.

The motors may operate in chorus to provide optimal laser engraving. For example, the computer-executable instructions may induce movement in the aforementioned motors to produce a given engraving task. In such an example, the vertical motor 114 may drive the laser head 110, allowing laser engraving in a first axis, where the rotational motor 130 may rotate the gripping device, providing a second axis across the surface of the object 106. Yet further, the horizontal motor 888 may be actuated to provide the optimal distance between the laser head 110 and the object 106 surface, which, for an object 106 having an irregular surface, may require change during the engraving task. Moreover, the tilt motor 1206 may be actuated during an engraving task to angle the surface of the object 106 to a desirable angle pursuant to the incoming laser 111 (e.g., the surface being normal to the laser 111). Although the aforementioned description contemplates actuation of the motors “during” a given engraving task, the apparatus may utilize the aforementioned motors to position the object 106 in a preferred position before engaging the laser 111 and commencing the project.

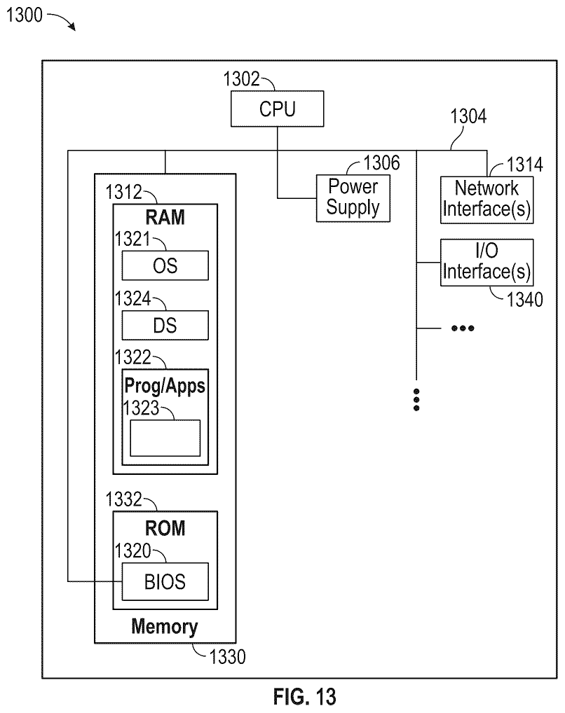

The external computer 1202 and/or the onboard computer 1204 may be embodied or may otherwise include any of the components of electronic device 1300, such that the external computer 1202 and/or the onboard computer 1204 may execute a laser engraving task as contemplated above. Accordingly, FIG. 13 illustrates a block diagram of an electronic device 1300 and accompanying processing system in accordance with one or more embodiments of the present disclosure. Instances of the electronic device 1300 may include the external computer 1202, the onboard computer 1204, servers and client devices. In general, the electronic device 1300 can include a processor/CPU 1302, memory 1330, a power supply 1306, and input/output (I/O) components/devices 1340, e.g., microphones, speakers, displays (e.g., the control screen 350, wherein the control screen 350 may also be interactive, such as a touch screen or may otherwise include user controls), touchscreens, keyboards, mice, keypads, microscopes, GPS components, cameras, heart rate sensors, light sensors, accelerometers, targeted biometric sensors, etc., which may be operable, for example, to provide graphical user interfaces or text user interfaces.

A user may provide input via a touchscreen or an interactive display of an electronic device 1300. A touchscreen may determine whether a user is providing input by, for example, determining whether the user is touching the touchscreen with a part of the user's body such as his or her fingers. The electronic device 1300 can also include a communications bus 1304 that connects the aforementioned elements of the electronic device 1300 (e.g., providing engraving instructions from external computing device 1202 to onboard computer 1204). Network interfaces 1314 can include a receiver and a transmitter (or transceiver), and one or more antennas for wireless communications (e.g., wirelessly providing engraving instructions from external computing device 1202 to onboard computer 1204).

The processor 1302 can include one or more of any type of processing device, e.g., a Central Processing Unit (CPU), and a Graphics Processing Unit (GPU). Also, for example, the processor can be central processing logic, or other logic, may include hardware, firmware, software, or combinations thereof, to perform one or more functions or actions, or to cause one or more functions or actions from one or more other components. Also, based on a desired application or need, central processing logic, or other logic, may include, for example, a software-controlled microprocessor, discrete logic, e.g., an Application Specific Integrated Circuit (ASIC), a programmable/programmed logic device, memory device containing instructions, etc., or combinatorial logic embodied in hardware. Furthermore, logic may also be fully embodied as software.

The memory 1330, which can include Random Access Memory (RAM) 1312 and Read Only Memory (ROM) 1332, can be enabled by one or more of any type of memory device, e.g., a primary (directly accessible by the CPU) or secondary (indirectly accessible by the CPU) storage device (e.g., flash memory, magnetic disk, optical disk, and the like). The RAM can include an operating system 1321, data storage 1324, which may include one or more databases, and programs and/or applications 1322, which can include, for example, software aspects of the program 1323. The ROM 1332 can also include Basic Input/Output System (BIOS) 1320 of the electronic device.

Software aspects of the program 1323 are intended to broadly include or represent all programming, applications, algorithms, models, software and other tools necessary to implement or facilitate methods and systems according to embodiments of the present disclosure. The elements may exist on a single computer or be distributed among multiple computers, servers, devices or entities.

The power supply 1306 contains one or more power components and facilitates supply and management of power to the electronic device 1300.

The input/output components, including Input/Output (I/O) interfaces 1340, can include, for example, any interfaces for facilitating communication between any components of the electronic device 1300, components of external devices, and end users. For example, such components can include a network card that may be an integration of a receiver, a transmitter, a transceiver, and one or more input/output interfaces. A network card, for example, can facilitate wired or wireless communication with other devices of a network. In cases of wireless communication, an antenna can facilitate such communication. Also, some of the input/output interfaces 1340 and the bus 1304 can facilitate communication between components of the electronic device 1300, and in an example can case processing performed by the processor 1302.

As a nonlimiting example, the laser engraving apparatus may include: a laser head slidably coupled to a vertical gantry, the laser head mechanically coupled to a vertical motor, wherein the vertical motor is configured to drive the laser head vertically upon the vertical gantry; a gripping device slidably coupled to a horizontal rail, the gripping device configured to selectively receive an object, the gripping device mechanically coupled to a rotational motor, wherein actuation of the rotational motor rotates the gripping device; a carriage block comprising a receiving member disposed on a bottom surface of the carriage block, the receiving member sized to partially surround a portion of the horizontal rail, the carriage block adapted to accept a lead screw, wherein the lead screw at least partially extends through the carriage block, wherein actuation of the lead screw induces movement in the carriage block along the horizontal rail; a chuck mount, defined as a vertical planar member, disposed on the carriage block, the chuck mount attached to a motor housing, the motor housing bearing the gripping device and the rotational motor; a working internal volume housing at least the laser head and the gripping device; a laser source disposed in a laser emission compartment, the laser emission compartment physically separated from the working internal volume, the laser source producing a laser, wherein said laser is directed to the laser head via one or more mirrors; a gantry support disposed along a length of the vertical gantry and affixed to a work surface, the gantry support comprising a gantry support aperture, wherein the laser traverses the gantry support aperture upon direction from the laser source to the laser head.

In one or more embodiments, a method to engrave an object with a vertical laser engraving machine may comprise the steps of: engaging the object with a gripping device; determining a taper angle of an object surface; tilting, via a tilt motor, the gripping device until the object surface is parallel to a vertical gantry of the laser engraving machine; moving, via a horizontal motor, the gripping device along a horizontal rail until the object surface is a predetermined distance from a laser head, wherein the predetermined distance is an optimal focusing distance between the laser head and the object surface to perform laser engraving, and wherein the laser head is slidably coupled to the vertical gantry; emitting a laser from the laser head, the laser configured to engrave the object; moving, via a vertical motor, the laser head along the vertical gantry; and rotating, via a rotational motor, the object about a gripping device axis.

Aspects of the present disclosure relate to a method, wherein determining the taper angle of the object surface includes measuring the horizontal distance from the laser head to a first point of the object surface, measuring the horizontal distance from the laser head to a second point of the object surface, measuring the vertical distance between the first point and the second point, determining the taper angle based on the measured horizontal distances between the laser head and the first point and second point and the vertical distance between the first point and the second point.

Aspects of the present disclosure relate to a method, wherein the object surface is parallel to the axis of the vertical gantry when a first point on the object is a first distance from the vertical gantry and a second point on the object is a second distance from the vertical gantry, and wherein the first distance and the second distance are equal.

Aspects of the present disclosure relate to a method, wherein the gripping device includes a plurality of interchangeable jaws, wherein the plurality of interchangeable jaws are self-centering.

Aspects of the present disclosure relate to a method, wherein the plurality of interchangeable jaws are centered about the gripping device axis running through the center of the gripping device, and wherein the plurality of interchangeable jaws is configured to engage the object so that the object is concentric with the gripping device axis.

Aspects of the present disclosure relate to a method, the method further including entering or inputting a series of commands into a processing unit, the processing unit configured to, based on the series of commands, control the tilting of the gripping device, the rotation of the gripping device, movement of the gripping device along the horizontal rail, the movement of the laser head along the vertical gantry, and an emission of the laser in order to engrave a predetermined pattern onto the object. In one or more embodiments, the processor may control two or more of the motors and laser emission simultaneously. For example, the processor may simultaneously control the vertical motor, rotational motor, and laser emitter so that the laser emits as the laser head moves in the vertical direction while the object is being rotated. Such a combination of movements may result in a diagonal engraving line or pattern. In another example, the processor may simultaneously control the horizontal motor, tilt motor, vertical motor, and laser emitter. The processor may be configured to simultaneously control any combination of the vertical motor, horizontal motor, rotational motor, tilt motor, and laser emitter. In other embodiments, the processor may only be configured to simultaneously control one of the motors and the laser emitter.

Particular terminology used when describing certain features or aspects of this application should not be taken to imply that the terminology is limited to any specific characteristics, feature, or aspects. The use of the “horizontal,” “vertical,” “parallel,” “perpendicular” and the like are used for distinguishing between elements construed broadly and may refer to any positioning. For example, “horizontal” encompasses all positions including planes angles less than, equal to, or greater than parallel to the horizon. Likewise, the term “vertical” encompasses all positions including less than, equal to, or greater than 90 degrees relative to horizontal. The terms “parallel” and “perpendicular” are used for describing a relationship between elements and not necessarily for describing a particle angle.

Other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

Various elements, which are described herein in the context of one or more embodiments, may be provided separately or in any suitable subcombination. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

All references, patents and patent applications and publications that are cited or referred to in this application are incorporated in their entirety herein by reference. Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A laser engraving apparatus comprising:
a vertical gantry defining a vertical axis;
a horizontal rail defining a horizontal axis;
a laser head secured to the vertical gantry by a laser mount;
a gripping device indirectly slidably coupled to the horizontal rail, the gripping device configured to selectively receive an object;
a vertical motor in communication with the laser mount; and
a rotational motor in communication with the gripping device.

2. The laser engraving apparatus of claim 1, wherein the vertical motor is in mechanical communication with the laser mount to permit movement of the laser head along the vertical axis.

3. The laser engraving apparatus of claim 1, wherein a rotational motor is in mechanical communication with the gripping device to permit rotational movement of the gripping device.

4. The laser engraving apparatus of claim 1, wherein the gripping device is secured to the horizontal rail by a chuck mount configured to permit horizontal movement of the gripping device.

5. The laser engraving apparatus of claim 1, wherein the gripping device is configured to tilt relative to the vertical axis.

6. The laser engraving apparatus of claim 5, wherein a tilt motor is configured to control a tilt of the gripping device.

7. The laser engraving apparatus of claim 1, wherein the gripping device is a chuck.

8. The laser engraving apparatus of claim 7, wherein the chuck comprises at least one interchangeable jaw.

9. The laser engraving apparatus of claim 8, wherein the at least one interchangeable jaw is self-centering.

10. A vertical laser engraving apparatus comprising:
a vertical gantry defining a vertical axis;
a horizontal rail defining a horizontal axis;
a laser head secured to the vertical gantry by a laser mount, the laser mount slidably coupled to the vertical gantry;
a gripping device indirectly slidably coupled to the horizontal rail, the gripping device configured to selectively receive an object;
a vertical motor in communication with the laser mount, the vertical motor configured to move the laser mount along the vertical gantry;
a horizontal motor in communication with the gripping device, the horizontal motor configured to move the gripping device along the horizontal rail;
a rotational motor in communication with the gripping device, the rotational motor configured to rotate the gripping device; and
a tilt motor in communication with the gripping device, the tilt motor configured to tilt the gripping device.

11. The vertical laser engraving apparatus of claim 10, wherein the tilt motor is configured to tilt the gripping device until a surface of the object is parallel to an axis of the vertical gantry.

12. The vertical laser engraving apparatus of claim 11, wherein the surface of the object is parallel to the axis of the vertical gantry when a first point on the object is a first distance from the vertical gantry and a second point on the object is a second distance from the vertical gantry, and wherein the first distance and the second distance are equal.

13. The vertical laser engraving apparatus of claim 10, wherein the gripping device comprises a plurality of interchangeable jaws, wherein the plurality of interchangeable jaws are self-centering.

14. The vertical laser engraving apparatus of claim 13, wherein the plurality of interchangeable jaws are centered about a gripping device axis running through the center of the gripping device, and wherein the plurality of interchangeable jaws is configured to engage the object so that the object is concentric with the gripping device axis.

15. A laser engraving apparatus comprising:
a laser head slidably coupled to a vertical gantry, the laser head mechanically coupled to a vertical motor, wherein the vertical motor is configured to drive the laser head vertically upon the vertical gantry;
a gripping device indirectly slidably coupled to a horizontal rail, the gripping device configured to selectively receive an object, the gripping device mechanically coupled to a rotational motor,
wherein actuation of the rotational motor rotates the gripping device;
a carriage block comprising a receiving member disposed on a bottom surface of the carriage block, the receiving member sized to partially surround a portion of the horizontal rail, the carriage block adapted to accept a lead screw,
wherein the lead screw at least partially extends through the carriage block,
wherein actuation of the lead screw induces movement in the carriage block along the horizontal rail;
a chuck mount, defined as a vertical planar member, disposed on the carriage block, the chuck mount attached to a motor housing, the motor housing bearing the gripping device and the rotational motor;
a working internal volume housing at least the laser head and the gripping device;
a laser source disposed in a laser emission compartment, the laser emission compartment physically separated from the working internal volume, the laser source producing a laser,
wherein said laser is directed to the laser head via one or more mirrors;
a gantry support disposed along a length of the vertical gantry and affixed to a work surface, the gantry support comprising a gantry support aperture,
wherein the laser traverses the gantry support aperture upon direction from the laser source to the laser head.

16. The laser engraving apparatus of claim 15 further comprising a tilt adjustment knob disposed on the chuck mount, wherein actuation of the tilt adjustment knob tilts the gripping device by an angle relative to the vertical gantry.

17. The laser engraving apparatus of claim 15 further comprising a horizontal adjuster disposed on the lead screw, wherein actuation of the horizontal adjuster moves the carriage block, and indirectly the gripping device, along the horizontal rail.

18. The laser engraving apparatus of claim 15 further comprising a tilt motor, wherein actuation of the tilt motor tilts the gripping device by an angle relative to the vertical gantry.

19. The laser engraving apparatus of claim 15 further comprising a horizontal motor in mechanical communication with the lead screw, wherein actuation of the horizontal motor moves the carriage block, and indirectly the gripping device, along the horizontal rail.

20. The laser engraving apparatus of claim 15, the one or more mirrors comprising a first mirror, a second mirror, and a head mirror, the first mirror and the second mirror disposed on a laser engraving floor, and the head mirror disposed on the laser head, wherein each of the first mirror, the second mirror, and the head mirror, alter the laser's direction by 90 degrees.
